(19) United States
(12) Patent Application Publication
(10) Pub. No.: US 2018/0093671 A1
(43) Pub. Date: Apr. 5, 2018

(54) SYSTEMS AND METHODS FOR ADJUSTING SPEED FOR AN UPCOMING LANE CHANGE IN AUTONOMOUS VEHICLES

(71) Applicant: GM GLOBAL TECHNOLOGY OPERATIONS LLC, Detroit, MI (US)

(72) Inventors: Jeremy Allan, San Francisco, CA (US); Ryan Holben, San Francisco, CA (US)

(73) Assignee: GM GLOBAL TECHNOLOGY OPERATIONS LLC, Detroit, MI (US)

(21) Appl. No.: 15/820,278

(22) Filed: Nov. 21, 2017

(51) Int. Cl. B60W 30/18; G05D 1/02; B62D 15/02

(52) U.S. Cl. CPC B60W 30/18163; B62D 15/0255; G05D 1/0223

(57) ABSTRACT

Systems and method are provided for speed management of an autonomous vehicle during a lane change. The method comprises identifying a planned future lane change, identifying the starting position of the future lane change, measuring the travel distance available to complete the lane change, determining the maximum speed for the autonomous vehicle at the lane change starting position based on the travel distance, setting an interpolated speed limit at a plurality of intermediate points between the current position and the lane change starting position, setting a target speed limit at each of the intermediate points by choosing for each intermediate point the minimum of the interpolated speed limit at the intermediate point and any additional speed limit at the intermediate point, and communicating the target speed limit at the intermediate points as speed constraints to a vehicle control module.

### TECHNICAL FIELD

The present disclosure generally relates to autonomous vehicles, and more particularly relates to systems and methods for adjusting the speed of an autonomous vehicle in preparation for a lane change.

### BACKGROUND

An autonomous vehicle is a vehicle that is capable of sensing its environment and navigating with little or no user input. It does so by using sensing devices such as radar, lidar, image sensors, and the like. Autonomous vehicles further use information from global positioning systems (GPS) technology, navigation systems, vehicle-to-vehicle communication, vehicle-to-infrastructure technology, and/or drive-by-wire systems to navigate the vehicle.

While recent years have seen significant advancements in autonomous vehicles, such vehicles might still be improved in a number of respects. For example, the control algorithms in an autonomous vehicle may not be optimized to enhance the comfort of the passenger during maneuvers such as lane changes.

Accordingly, it is desirable to provide systems and methods for improving the comfort of the passenger of an autonomous vehicle during a lane change maneuver. Furthermore, other desirable features and characteristics of the present invention will become apparent from the subsequent detailed description and the appended claims, taken in conjunction with the accompanying drawings and the foregoing technical field and background.

### SUMMARY

Systems and method are provided for speed management in an autonomous vehicle. In one embodiment, a processor-implemented method in an autonomous vehicle for speed management during a lane change includes identifying, by a processor, a planned future lane change, identifying, by the processor, the starting position of the future lane change, measuring, by the processor, the travel distance available to complete the lane change, determining, by the processor, the maximum speed for the autonomous vehicle at the lane change starting position based on the travel distance, setting, by the processor, an interpolated speed limit at a plurality of intermediate points between the current position and the lane change starting position, setting, by the processor, a target speed limit at each of the intermediate points by choosing for each intermediate point the minimum of the interpolated speed limit at the intermediate point and any additional speed limit at the intermediate point, and communicating, by the processor, the target speed limit at the intermediate points as speed constraints to a vehicle control module.

In one embodiment, identifying a planned future lane change includes receiving a plurality of road segments from a router module, parsing the road segments to identify a potential lane change, and determining that the potential lane change is the planned future lane change.

In one embodiment, determining that the potential lane change is the planned future lane change includes determining the travel distance available to complete the lane change, determining that the potential lane change is not the planned future lane change when the travel distance available to complete the lane change is below a threshold level, and determining that the potential lane change is the planned future lane change when the travel distance available to complete the lane change is greater than or equal to a threshold level.

In one embodiment, measuring the travel distance available to complete the lane change includes measuring the distance available for the lane change as allowed by road markings.

In one embodiment, determining the maximum speed for the autonomous vehicle at the lane change starting position includes determining the maximum speed based on a maximum lateral acceleration for a safe lane change and/or determining the maximum speed based on a maximum lateral acceleration for passenger comfort during the lane change.

In one embodiment, the maximum speed (v_max) for the autonomous vehicle at the lane change starting position is determined by v_max=(length_of_lane_change)*sqrt((a_lat)/(2*lane_sep)), wherein a_lat=lateral acceleration and lane_sep=estimated width of the lane.

In one embodiment, setting an interpolated speed limit at a plurality of intermediate points between the current position and the lane change starting position includes identifying a plurality of intermediate points between the current position and the lane change starting position and identifying an interpolated speed limit at each of the intermediate points between the current position and the lane change starting position.

In one embodiment, identifying a plurality of intermediate points includes identifying a plurality of intermediate points between the current position and the lane change starting position with a constant, fixed distance between each intermediate point.

In one embodiment, the fixed distance is 0.5 meters between each intermediate point.

In one embodiment, identifying an interpolated speed limit includes linearly interpolating between the speed limit at the current position and the speed limit at the lane change starting position to identify an interpolated speed limit at each of the intermediate points.

In one embodiment, an additional speed limit includes a speed limit determined based on some other path travel condition such as a speed bump, legal speed limit, or obstacle in travel path.

In one embodiment, the vehicle control module controls the vehicle to not exceed the target speed limits at the lane change starting position and the intermediate points.

In another embodiment, a system is provided for controlling an autonomous vehicle. The autonomous vehicle includes a speed management module that includes one or more processors configured by programming instructions encoded in non-transient computer readable media. The speed management module is configured to identify a planned future lane change, identify the starting position of the future lane change, measure the travel distance available to complete the lane change, determine a maximum speed for the autonomous vehicle at the lane change starting position based on the travel distance, set an interpolated speed limit at a plurality of intermediate points between the current position and the lane change starting position, set a target speed limit at each of the intermediate points by choosing for each intermediate point the minimum of the interpolated speed limit at the intermediate point and any additional speed limit at the intermediate point, and communicate the target speed limit at the intermediate points as speed constraints to a control module.

In one embodiment, the speed management module is further configured to receive a plurality of road segments from a router module that includes one or more processors configured by programming instructions encoded in non-transient computer readable media wherein the router module is configured to plan the route of an autonomous vehicle, provide future path segments of the route, and identify a lane change in the future path segments.

In one embodiment, the speed management module is further configured to parse the road segments to identify a potential lane change and determine that the potential lane change is a future lane change.

In one embodiment, the speed management module is further configured to measure the travel distance available to complete the lane change, determine that the potential lane change is not a future lane change when the travel distance available to complete the lane change is below a threshold level, and determine that the potential lane change is a future lane change when the travel distance available to complete the lane change is greater than or equal to a threshold level.

In one embodiment, the speed management module is further configured to set an interpolated speed limit at the plurality of intermediate points between the current position and the lane change starting position by linearly interpolating between the speed limit at the current position and the speed limit at the lane change starting position to identify an interpolated speed limit at each of the intermediate points.

In one embodiment, the system further includes a control module that includes one or more processors configured by programming instructions encoded in non-transient computer readable media wherein the control module is configured to receive the speed constraints and control the vehicle to not exceed the target speed limits set in the speed constraints.

In another embodiment, an autonomous vehicle is provided. The autonomous vehicle includes a sensing device, a router module, a speed management module, and a control module. The sensing device is configured to determine the location of the vehicle along a route. The router module includes one or more processors configured by programming instructions encoded in non-transient computer readable media and is configured to provide road segments for the route based on the current location of the vehicle and designate a planned future lane change in the road segments. The speed management module includes one or more processors configured by programming instructions encoded in non-transient computer readable media and is configured to identify the planned future lane change, identifying the starting position of the future lane change, measure the travel distance available to complete the lane change, determine a maximum speed for the autonomous vehicle at the lane change starting position based on the travel distance, set an interpolated speed limit at a plurality of intermediate points between the current position and the lane change starting position, set a target speed limit at each of the intermediate points by choosing for each intermediate point the minimum of the interpolated speed limit at the intermediate point and any additional speed limit at the intermediate point, and communicate the target speed limit at the intermediate points as speed constraints to a control module. The control module includes one or more processors configured by programming instructions encoded in non-transient computer readable media and is configured to receive the speed constraints and control the vehicle to not exceed the target speed limits set in the speed constraints.

In one embodiment, the speed management module is further configured to receive the plurality of road segments from the router module, parse the road segments to identify a potential lane change, and determine that the potential lane change is a future lane change.

In one embodiment, the speed management module is further configured to measure the travel distance available to complete the lane change, determine that the potential lane change is not a future lane change when the travel distance available to complete the lane change is below a threshold level, and determine that the potential lane change is a future lane change when the travel distance available to complete the lane change is greater than or equal to a threshold level.

### DESCRIPTION OF THE DRAWINGS

The exemplary embodiments will hereinafter be described in conjunction with the following drawing figures, wherein like numerals denote like elements, and wherein:

FIG. 1 is a functional block diagram illustrating an autonomous vehicle that includes a lane change speed management system, in accordance with various embodiments;

FIG. 2 is a functional block diagram illustrating a transportation system having one or more autonomous vehicles as shown in FIG. 1, in accordance with various embodiments;

FIG. 3 is functional block diagram illustrating an autonomous driving system (ADS) associated with an autonomous vehicle, in accordance with various embodiments;

FIG. 4 presents a top-down view of an example scenario useful in understanding the present subject matter, in accordance with various embodiments;

FIG. 5 is a block diagram depicting an example system in an autonomous vehicle for controlling the speed of the autonomous vehicle during a lane change, in accordance with various embodiments;

FIG. 6 is a process flow chart depicting an example process that can be performed by an example lane change speed management system, in accordance with various embodiments;

FIG. 7 is a process flow chart depicting another example process that can be performed by an example lane change speed management system, in accordance with various embodiments; and

FIG. 8 is a process flow chart depicting another example process that can be performed by an example lane change speed management system, in accordance with various embodiments.

### DETAILED DESCRIPTION

The following detailed description is merely exemplary in nature and is not intended to limit the application and uses. Furthermore, there is no intention to be bound by any expressed or implied theory presented in the preceding technical field, background, summary, or the following detailed description. As used herein, the term “module” refers to any hardware, software, firmware, electronic control component, processing logic, and/or processor device, individually or in any combination, including without limitation: application specific integrated circuit (ASIC), a field-programmable gate-array (FPGA), an electronic circuit, a processor (shared, dedicated, or group) and memory that executes one or more software or firmware programs, a combinational logic circuit, and/or other suitable components that provide the described functionality.

Embodiments of the present disclosure may be described herein in terms of functional and/or logical block components and various processing steps. It should be appreciated that such block components may be realized by any number of hardware, software, and/or firmware components configured to perform the specified functions. For example, an embodiment of the present disclosure may employ various integrated circuit components, e.g., memory elements, digital signal processing elements, logic elements, look-up tables, or the like, which may carry out a variety of functions under the control of one or more microprocessors or other control devices. In addition, those skilled in the art will appreciate that embodiments of the present disclosure may be practiced in conjunction with any number of systems, and that the systems described herein is merely exemplary embodiments of the present disclosure.

For the sake of brevity, conventional techniques related to signal processing, data transmission, signaling, control, machine learning models, radar, lidar, image analysis, and other functional aspects of the systems (and the individual operating components of the systems) may not be described in detail herein. Furthermore, the connecting lines shown in the various figures contained herein are intended to represent example functional relationships and/or physical couplings between the various elements. It should be noted that many alternative or additional functional relationships or physical connections may be present in an embodiment of the present disclosure.

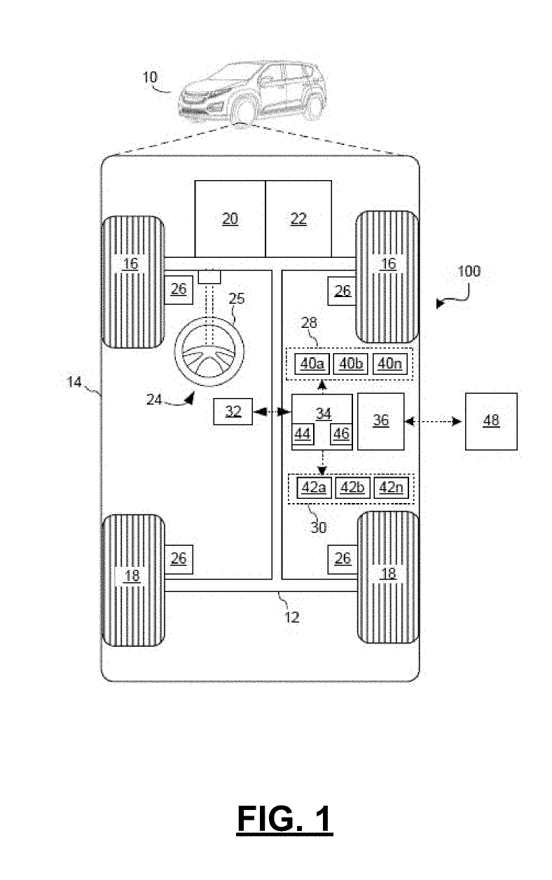

With reference to FIG. 1, a lane change speed management system shown generally as 100 is associated with a vehicle 10 in accordance with various embodiments. In general, lane change speed management system (or simply “system”) 100 provides speed constraints for use leading up to and during lane change maneuvers.

As depicted in FIG. 1, the vehicle 10 generally includes a chassis 12, a body 14, front wheels 16, and rear wheels 18. The body 14 is arranged on the chassis 12 and substantially encloses components of the vehicle 10. The body 14 and the chassis 12 may jointly form a frame. The wheels 16-18 are each rotationally coupled to the chassis 12 near a respective corner of the body 14.

In various embodiments, the vehicle 10 is an autonomous vehicle and the lane change speed management system 100 is incorporated into the autonomous vehicle 10. The autonomous vehicle 10 is, for example, a vehicle that is automatically controlled to carry passengers from one location to another. The vehicle 10 is depicted in the illustrated embodiment as a passenger car, but it should be appreciated that any other vehicle, including motorcycles, trucks, sport utility vehicles (SUVs), recreational vehicles (RVs), marine vessels, aircraft, etc., can also be used.

In an exemplary embodiment, the autonomous vehicle 10 corresponds to a level four or level five automation system under the Society of Automotive Engineers (SAE) “J3016” standard taxonomy of automated driving levels. Using this terminology, a level four system indicates “high automation,” referring to a driving mode in which the automated driving system performs all aspects of the dynamic driving task, even if a human driver does not respond appropriately to a request to intervene. A level five system, on the other hand, indicates “full automation,” referring to a driving mode in which the automated driving system performs all aspects of the dynamic driving task under all roadway and environmental conditions that can be managed by a human driver. It will be appreciated, however, the embodiments in accordance with the present subject matter are not limited to any particular taxonomy or rubric of automation categories. Furthermore, systems in accordance with the present embodiment may be used in conjunction with any vehicle in which the present subject matter may be implemented, regardless of its level of autonomy.

As shown, the autonomous vehicle 10 generally includes a propulsion system 20, a transmission system 22, a steering system 24, a brake system 26, a sensor system 28, an actuator system 30, at least one data storage device 32, at least one controller 34, and a communication system 36. The propulsion system 20 may, in various embodiments, include an internal combustion engine, an electric machine such as a traction motor, and/or a fuel cell propulsion system. The transmission system 22 is configured to transmit power from the propulsion system 20 to the vehicle wheels 16 and 18 according to selectable speed ratios. According to various embodiments, the transmission system 22 may include a step-ratio automatic transmission, a continuously-variable transmission, or other appropriate transmission.

The brake system 26 is configured to provide braking torque to the vehicle wheels 16 and 18. Brake system 26 may, in various embodiments, include friction brakes, brake by wire, a regenerative braking system such as an electric machine, and/or other appropriate braking systems.

The steering system 24 influences a position of the vehicle wheels 16 and/or 18. While depicted as including a steering wheel 25 for illustrative purposes, in some embodiments contemplated within the scope of the present disclosure, the steering system 24 may not include a steering wheel.

The sensor system 28 includes one or more sensing devices 40a-40n that sense observable conditions of the exterior environment and/or the interior environment of the autonomous vehicle 10 (such as the state of one or more occupants) and generate sensor data relating thereto. Sensing devices 40a-40n might include, but are not limited to, radars (e.g., long-range, medium-range-short range), lidars, global positioning systems, optical cameras (e.g., forward facing, 360-degree, rear-facing, side-facing, stereo, etc.), thermal (e.g., infrared) cameras, ultrasonic sensors, odometry sensors (e.g., encoders) and/or other sensors that might be utilized in connection with systems and methods in accordance with the present subject matter.

The actuator system 30 includes one or more actuator devices 42a-42n that control one or more vehicle features such as, but not limited to, the propulsion system 20, the transmission system 22, the steering system 24, and the brake system 26. In various embodiments, autonomous vehicle 10 may also include interior and/or exterior vehicle features not illustrated in FIG. 1, such as various doors, a trunk, and cabin features such as air, music, lighting, touch-screen display components (such as those used in connection with navigation systems), and the like.

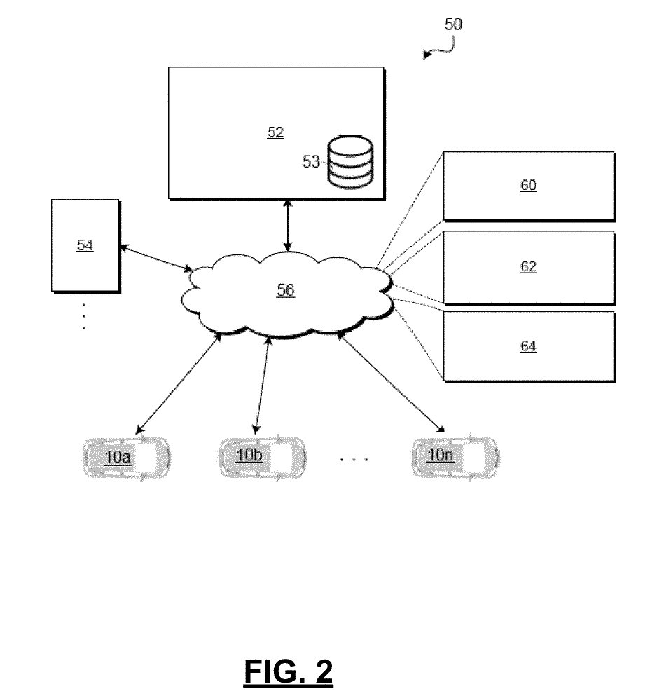

The data storage device 32 stores data for use in automatically controlling the autonomous vehicle 10. In various embodiments, the data storage device 32 stores defined maps of the navigable environment. In various embodiments, the defined maps may be predefined by and obtained from a remote system (described in further detail with regard to FIG. 2). For example, the defined maps may be assembled by the remote system and communicated to the autonomous vehicle 10 (wirelessly and/or in a wired manner) and stored in the data storage device 32. Route information may also be stored within data storage device 32—i.e., a set of road segments (associated geographically with one or more of the defined maps) that together define a route that the user may take to travel from a start location (e.g., the user's current location) to a target location. As will be appreciated, the data storage device 32 may be part of the controller 34, separate from the controller 34, or part of the controller 34 and part of a separate system.

The controller 34 includes at least one processor 44 and a computer-readable storage device or media 46. The processor 44 may be any custom-made or commercially available processor, a central processing unit (CPU), a graphics processing unit (GPU), an application specific integrated circuit (ASIC) (e.g., a custom ASIC implementing a neural network), a field programmable gate array (FPGA), an auxiliary processor among several processors associated with the controller 34, a semiconductor-based microprocessor (in the form of a microchip or chip set), any combination thereof, or generally any device for executing instructions. The computer readable storage device or media 46 may include volatile and nonvolatile storage in read-only memory (ROM), random-access memory (RAM), and keep-alive memory (KAM), for example. KAM is a persistent or non-volatile memory that may be used to store various operating variables while the processor 44 is powered down. The computer-readable storage device or media 46 may be implemented using any of a number of known memory devices such as PROMs (programmable read-only memory), EPROMs (electrically PROM), EEPROMs (electrically erasable PROM), flash memory, or any other electric, magnetic, optical, or combination memory devices capable of storing data, some of which represent executable instructions, used by the controller 34 in controlling the autonomous vehicle 10. In various embodiments, controller 34 is configured to implement a lane change speed management system as discussed in detail below.

The instructions may include one or more separate programs, each of which comprises an ordered listing of executable instructions for implementing logical functions. The instructions, when executed by the processor 44, receive and process signals (e.g., sensor data) from the sensor system 28, perform logic, calculations, methods and/or algorithms for automatically controlling the components of the autonomous vehicle 10, and generate control signals that are transmitted to the actuator system 30 to automatically control the components of the autonomous vehicle 10 based on the logic, calculations, methods, and/or algorithms. Although only one controller 34 is shown in FIG. 1, embodiments of the autonomous vehicle 10 may include any number of controllers 34 that communicate over any suitable communication medium or a combination of communication mediums and that cooperate to process the sensor signals, perform logic, calculations, methods, and/or algorithms, and generate control signals to automatically control features of the autonomous vehicle 10.

The communication system 36 is configured to wirelessly communicate information to and from other entities 48, such as but not limited to, other vehicles (“V2V” communication), infrastructure (“V2I” communication), networks (“V2N” communication), pedestrian (“V2P” communication), remote transportation systems, and/or user devices (described in more detail with regard to FIG. 2). In an exemplary embodiment, the communication system 36 is a wireless communication system configured to communicate via a wireless local area network (WLAN) using IEEE 802.11 standards or by using cellular data communication. However, additional or alternate communication methods, such as a dedicated short-range communications (DSRC) channel, are also considered within the scope of the present disclosure. DSRC channels refer to one-way or two-way short-range to medium-range wireless communication channels specifically designed for automotive use and a corresponding set of protocols and standards.

With reference now to FIG. 2, in various embodiments, the autonomous vehicle 10 described with regard to FIG. 1 may be suitable for use in the context of a taxi or shuttle system in a certain geographical area (e.g., a city, a school or business campus, a shopping center, an amusement park, an event center, or the like) or may simply be managed by a remote system. For example, the autonomous vehicle 10 may be associated with an autonomous-vehicle-based remote transportation system. FIG. 2 illustrates an exemplary embodiment of an operating environment shown generally at 50 that includes an autonomous-vehicle-based remote transportation system (or simply “remote transportation system”) 52 that is associated with one or more autonomous vehicles 10a-10n as described with regard to FIG. 1. In various embodiments, the operating environment 50 (all or a part of which may correspond to entities 48 shown in FIG. 1) further includes one or more user devices 54 that communicate with the autonomous vehicle 10 and/or the remote transportation system 52 via a communication network 56.

The communication network 56 supports communication as needed between devices, systems, and components supported by the operating environment 50 (e.g., via tangible communication links and/or wireless communication links). For example, the communication network 56 may include a wireless carrier system 60 such as a cellular telephone system that includes a plurality of cell towers (not shown), one or more mobile switching centers (MSCs) (not shown), as well as any other networking components required to connect the wireless carrier system 60 with a land communications system. Each cell tower includes sending and receiving antennas and a base station, with the base stations from different cell towers being connected to the MSC either directly or via intermediary equipment such as a base station controller. The wireless carrier system 60 can implement any suitable communications technology, including for example, digital technologies such as CDMA (e.g., CDMA2000), LTE (e.g., 4G LTE or 5G LTE), GSM/GPRS, or other current or emerging wireless technologies. Other cell tower/base station/MSC arrangements are possible and could be used with the wireless carrier system 60. For example, the base station and cell tower could be co-located at the same site or they could be remotely located from one another, each base station could be responsible for a single cell tower or a single base station could service various cell towers, or various base stations could be coupled to a single MSC, to name but a few of the possible arrangements.

Apart from including the wireless carrier system 60, a second wireless carrier system in the form of a satellite communication system 64 can be included to provide uni-directional or bi-directional communication with the autonomous vehicles 10a-10n. This can be done using one or more communication satellites (not shown) and an uplink transmitting station (not shown). Uni-directional communication can include, for example, satellite radio services, wherein programming content (news, music, etc.) is received by the transmitting station, packaged for upload, and then sent to the satellite, which broadcasts the programming to subscribers. Bi-directional communication can include, for example, satellite telephony services using the satellite to relay telephone communications between the vehicle 10 and the station. The satellite telephony can be utilized either in addition to or in lieu of the wireless carrier system 60.

A land communication system 62 may further be included that is a conventional land-based telecommunications network connected to one or more landline telephones and connects the wireless carrier system 60 to the remote transportation system 52. For example, the land communication system 62 may include a public switched telephone network (PSTN) such as that used to provide hardwired telephony, packet-switched data communications, and the Internet infrastructure. One or more segments of the land communication system 62 can be implemented through the use of a standard wired network, a fiber or other optical network, a cable network, power lines, other wireless networks such as wireless local area networks (WLANs), or networks providing broadband wireless access (BWA), or any combination thereof. Furthermore, the remote transportation system 52 need not be connected via the land communication system 62, but can include wireless telephony equipment so that it can communicate directly with a wireless network, such as the wireless carrier system 60.

Although only one user device 54 is shown in FIG. 2, embodiments of the operating environment 50 can support any number of user devices 54, including multiple user devices 54 owned, operated, or otherwise used by one person. Each user device 54 supported by the operating environment 50 may be implemented using any suitable hardware platform. In this regard, the user device 54 can be realized in any common form factor including, but not limited to: a desktop computer; a mobile computer (e.g., a tablet computer, a laptop computer, or a netbook computer); a smartphone; a video game device; a digital media player; a component of a home entertainment equipment; a digital camera or video camera; a wearable computing device (e.g., smart watch, smart glasses, smart clothing); or the like. Each user device 54 supported by the operating environment 50 is realized as a computer-implemented or computer-based device having the hardware, software, firmware, and/or processing logic needed to carry out the various techniques and methodologies described herein. For example, the user device 54 includes a microprocessor in the form of a programmable device that includes one or more instructions stored in an internal memory structure and applied to receive binary input to create binary output. In some embodiments, the user device 54 includes a GPS module capable of receiving GPS satellite signals and generating GPS coordinates based on those signals. In other embodiments, the user device 54 includes cellular communications functionality such that the device carries out voice and/or data communications over the communication network 56 using one or more cellular communications protocols, as are discussed herein. In various embodiments, the user device 54 includes a visual display, such as a touch-screen graphical display, or other display.

The remote transportation system 52 includes one or more backend server systems, not shown), which may be cloud-based, network-based, or resident at the particular campus or geographical location serviced by the remote transportation system 52. The remote transportation system 52 can be manned by a live advisor, an automated advisor, an artificial intelligence system, or a combination thereof. The remote transportation system 52 can communicate with the user devices 54 and the autonomous vehicles 10a-10n to schedule rides, dispatch autonomous vehicles 10a-10n, and the like. In various embodiments, the remote transportation system 52 stores store account information such as subscriber authentication information, vehicle identifiers, profile records, biometric data, behavioral patterns, and other pertinent subscriber information.

In accordance with a typical use case workflow, a registered user of the remote transportation system 52 can create a ride request via the user device 54. The ride request will typically indicate the passenger's desired pickup location (or current GPS location), the desired destination location (which may identify a predefined vehicle stop and/or a user-specified passenger destination), and a pickup time. The remote transportation system 52 receives the ride request, processes the request, and dispatches a selected one of the autonomous vehicles 10a-10n (when and if one is available) to pick up the passenger at the designated pickup location and at the appropriate time. The transportation system 52 can also generate and send a suitably configured confirmation message or notification to the user device 54, to let the passenger know that a vehicle is on the way.

As can be appreciated, the subject matter disclosed herein provides certain enhanced features and functionality to what may be considered as a standard or baseline autonomous vehicle 10 and/or an autonomous vehicle based remote transportation system 52. To this end, an autonomous vehicle and autonomous vehicle based remote transportation system can be modified, enhanced, or otherwise supplemented to provide the additional features described in more detail below.

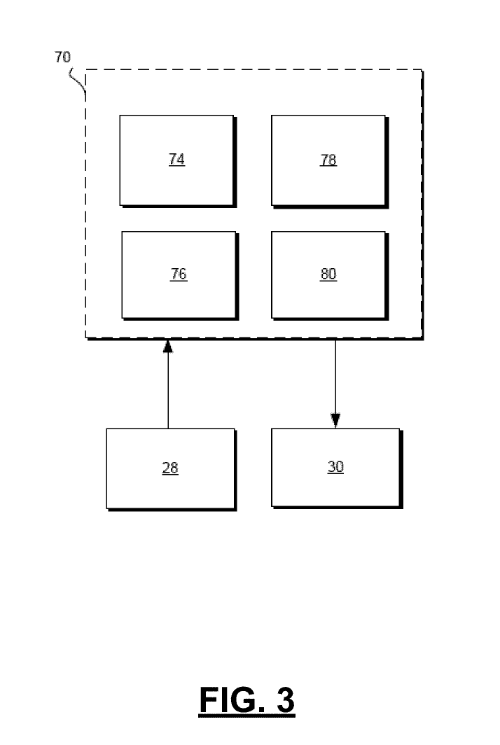

In accordance with various embodiments, controller 34 implements an autonomous driving system (ADS) 70 as shown in FIG. 3. That is, suitable software and/or hardware components of controller 34 (e.g., processor 44 and computer-readable storage device 46) are utilized to provide an autonomous driving system 70 that is used in conjunction with vehicle 10.

In various embodiments, the instructions of the autonomous driving system 70 may be organized by function or system. For example, as shown in FIG. 3, the autonomous driving system 70 can include a perception system 74, a positioning system 76, a path planning system 78, and a vehicle control system 80. As can be appreciated, in various embodiments, the instructions may be organized into any number of systems (e.g., combined, further partitioned, etc.) as the disclosure is not limited to the present examples.

In various embodiments, the perception system 74 synthesizes and processes the acquired sensor data and predicts the presence, location, classification, and/or path of objects and features of the environment of the vehicle 10. In various embodiments, the perception system 74 can incorporate information from multiple sensors (e.g., sensor system 28), including but not limited to cameras, lidars, radars, and/or any number of other types of sensors.

The positioning system 76 processes sensor data along with other data to determine a position (e.g., a local position relative to a map, an exact position relative to a lane of a road, a vehicle heading, etc.) of the vehicle 10 relative to the environment. As can be appreciated, a variety of techniques may be employed to accomplish this localization, including, for example, simultaneous localization and mapping (SLAM), particle filters, Kalman filters, Bayesian filters, and the like.

The path planning system 78 processes sensor data along with other data to determine a path for the vehicle 10 to follow. The vehicle control system 80 generates control signals for controlling the vehicle 10 according to the determined path.

In various embodiments, the controller 34 implements machine learning techniques to assist the functionality of the controller 34, such as feature detection/classification, obstruction mitigation, route traversal, mapping, sensor integration, ground-truth determination, and the like.

In various embodiments, all or parts of the lane change speed management system 100 may be included within the positioning system 76, the path planning system 78, and/or the vehicle control system 80. As mentioned briefly above, the lane change speed management system 100 of FIG. 1 is configured to reduce the speed of an autonomous vehicle 10 before an upcoming lane change.

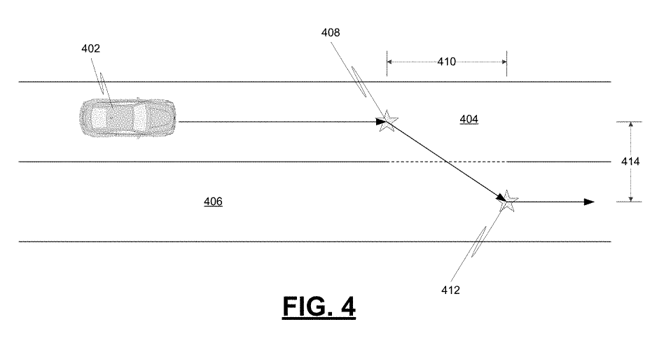

FIG. 4 presents a top-down view of an example scenario useful in understanding the present subject matter. More particularly, FIG. 4 illustrates an autonomous vehicle 402 traveling in a first lane 404 that is adjacent to a second lane 406. A lane change has been planned for the autonomous vehicle 402 wherein at a lane change starting position 408 the autonomous vehicle 402 will commence changing its travel path from the first lane 404 to the second lane 406. The lane change will continue for a travel distance 410 in the forward direction from the lane change starting position 408 to the lane change ending position 412. The lane change will also travel a certain distance 414 in the lateral direction from the center of the first lane 404 to the center of the second lane 406.

The example autonomous vehicle 402 is configured to adjust its speed during the lane change so that the lane change is made safely and in a manner that feels comfortable to passengers in the autonomous vehicle 402. The example autonomous vehicle 402 adjusts its speed by determining a maximum speed at which the vehicle should travel when it reaches the lane change starting position 408 and the maximum speed at which the vehicle should travel during intermediate points in between the current position of the autonomous vehicle 402 and the lane change starting position 408. The maximum speed (v_max) at which the autonomous vehicle 402 should travel when it reaches the lane change starting position 408 may be determined by v_max=(length_of_lane_change)*sqrt((a_lat)/(2*lane_sep)), wherein length_of_lane_change=travel distance 410, a_lat=lateral acceleration (e.g., maximum acceleration in the lateral direction for a safe and comfortable lane change) and lane_sep=estimated width of each lane involved in the lane change. In this example, a_lat=0.3 m/s² and lane_sep=3.6 m.

The example autonomous vehicle 402 performs an interpolation to determine an interpolated speed limit at each of the intermediate points between the current position of the autonomous vehicle 402 and the lane change starting position 408. In one example, the interpolation involves a linear interpolation. For instance, if there are four equal-distance intermediate points between the current position of the autonomous vehicle 402 and the lane change starting position 408, then at each intermediate point the speed limit should be reduced by at least 20% of the overall required speed reduction (e.g., if current speed is 50 mph and max speed at the lane change starting position 408 is 40 mph, then the max speed limit at intermediate point one should be 48 mph, the max speed limit at intermediate point two is 46 mph, the max speed limit at intermediate point three should be 44 mph, the max speed limit at intermediate point four should be 42 mph, and the max speed limit at the lane change starting position 408 should be 40 mph.) In other examples, other interpolation methods may be employed. The example autonomous vehicle 402 is operated to not exceed the lesser of the interpolated speed limits at the intermediate points and any other speed limits imposed at the intermediate point such as a speed limit imposed by traffic signs, road conditions, the detection of obstacles in the travel path, a speed bump, weather conditions, and others.

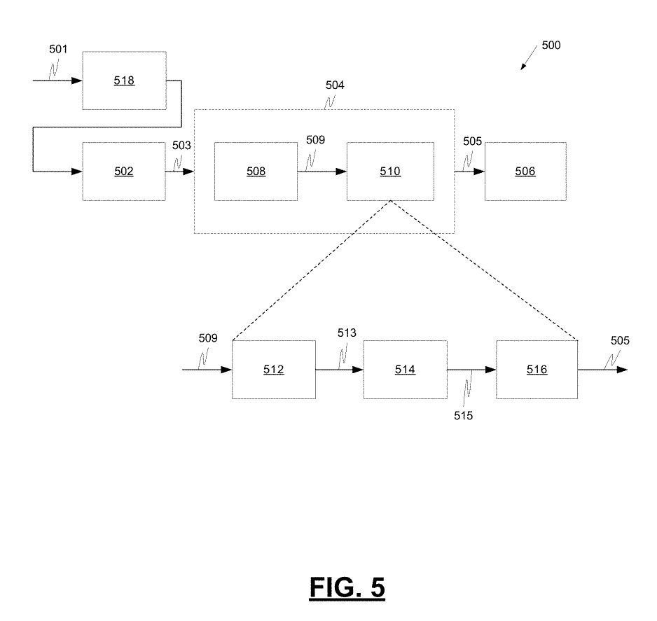

FIG. 5 is a block diagram depicting an example system 500 in an autonomous vehicle for controlling the speed of the autonomous vehicle during a lane change. The example system 500 includes a router module 502, a positioning module 518, a speed management module 504, and a control module 506. The router module 502 is configured to receive information regarding the destination of the autonomous vehicle and plan a route for the autonomous vehicle to take to reach the destination. The positioning system 518 is configured to receive sensor data 501 from sensors such as a GPS sensor and determine the autonomous vehicle's location and orientation on the planned route. The router module 502 is configured to receive the location and orientation of the vehicle from the positioning system 518 and provide road segments for the route that identify the planned vehicle path including lanes on which the vehicle should travel for some distance into the future.

The example speed management module 504 is configured to retrieve the road segments, identify a planned lane change in the road segments, determine a maximum speed limit for the lane change, determine speed limits for intermediate points leading up to the lane change, and communicate the speed limits at the lane change starting point and intermediate points as constraints 505 to the vehicle control module 506. The example vehicle control module 506, among other things, is configured to control the vehicle to not exceed the speed limits identified in the constraints 505.

The example speed management module 504 includes a lane change identifier module 508 and a speed planning module 510. The example lane change identifier module 508 is configured to identify a planned future lane change by parsing the road segments to identify a potential lane change and configured to determine whether the potential lane change is a future lane change. The example lane change identifier module 508 is configured to determine whether the potential lane change is a future lane change by determining the travel distance available to complete the lane change, determine that the potential lane change is not a future lane change when the travel distance available to complete the lane change is below a threshold level, and determine that the potential lane change is a future lane change when the travel distance available to complete the lane change is greater than or equal to a threshold level. In addition to determining that a potential lane change is a future lane change, the example speed management module 504 is configured to identify the starting position of the future lane change and measure the travel distance available to complete the lane change from the road segments. Measuring the travel distance available to complete the lane change in this example includes measuring the forward travel distance. In other examples, measuring the travel distance available to complete the lane change may include measuring the total diagonal travel distance. The lane change information 509, e.g., the starting position of the future lane change and the travel distance available to complete the lane change, may be communicated to the example speed planning module 510.

The example speed planning module 510 includes a maximum speed identifier module 512, an interpolation module 514, and a speed selection module 516. The example maximum speed identifier module 512 is configured to determine the maximum speed for safety and/or passenger comfort for the autonomous vehicle at the lane change starting position based on the travel distance. Determining the maximum speed for the autonomous vehicle at the lane change starting position may include determining the maximum speed based on a maximum lateral acceleration for a lane change for safety and/or passenger comfort. The maximum speed (v_max) for the autonomous vehicle at the lane change starting position may be determined by v_max=(length_of_lane_change)*sqrt((a_lat)/(2*lane_sep)), wherein a_lat=lateral acceleration and lane_sep=estimated width of the lane. In this example, a_lat=0.3 m/s² and lane_sep=3.6 m.

The example interpolation module 514 is configured to set an interpolated speed limit at a plurality of intermediate points between the current position and the lane change starting position. Setting an interpolated speed limit at a plurality of intermediate points may include identifying a plurality of intermediate points between the current position and the lane change starting position and identifying an interpolated speed limit at each of the intermediate points. Identifying a plurality of intermediate points may include identifying a plurality of intermediate points between the current position and the lane change starting position having a fixed distance between each intermediate point. The fixed distance in this example is 0.5 meters, but in other examples, other fixed distances may be used. Identifying an interpolated speed limit may include linearly interpolating between the speed limit at the current position and the speed limit at the lane change starting position to identify an interpolated speed limit at each of the intermediate points.

The example speed selection module 516 is configured to set a target speed limit at each of the intermediate points by choosing for each intermediate point the minimum of the interpolated speed limit at the intermediate point and any additional speed limit at the intermediate point. An additional speed limit may include a speed limit determined based on a road travel condition such as a speed bump, a speed limit imposed by traffic signs, adverse road conditions, the detection of obstacles in the travel path, weather conditions, and others.

An example lane change speed management system 100 may include any number of additional sub-modules embedded within the controller 34 which may be combined and/or further partitioned to similarly implement systems and methods described herein. Additionally, inputs to the lane change speed management system 100 may be received from the sensor system 28, received from other control modules (not shown) associated with the autonomous vehicle 10, received from the communication system 36, and/or determined/modeled by other sub-modules (not shown) within the controller 34 of FIG. 1. Furthermore, the inputs might also be subjected to preprocessing, such as sub-sampling, noise-reduction, normalization, feature-extraction, missing data reduction, and the like.

The various modules described above may be implemented as one or more machine learning models that undergo supervised, unsupervised, semi-supervised, or reinforcement learning and perform classification (e.g., binary or multiclass classification), regression, clustering, dimensionality reduction, and/or such tasks. Examples of such models include, without limitation, artificial neural networks (ANN) (such as a recurrent neural networks (RNN) and convolutional neural network (CNN)), decision tree models (such as classification and regression trees (CART)), ensemble learning models (such as boosting, bootstrapped aggregation, gradient boosting machines, and random forests), Bayesian network models (e.g., naive Bayes), principal component analysis (PCA), support vector machines (SVM), clustering models (such as K-nearest-neighbor, K-means, expectation maximization, hierarchical clustering, etc.), linear discriminant analysis models.

In some embodiments, training of any machine learning models used by system 100 occurs within a system remote from vehicle 10 (e.g., system 52 in FIG. 2) and is subsequently downloaded to vehicle 10 for use during normal operation of vehicle 10. In other embodiments, training occurs at least in part within controller 34 of vehicle 10, itself, and the model is subsequently shared with external systems and/or other vehicles in a fleet (such as depicted in FIG. 2). Training data may similarly be generated by vehicle 10 or acquired externally, and may be partitioned into training sets, validation sets, and test sets prior to training.

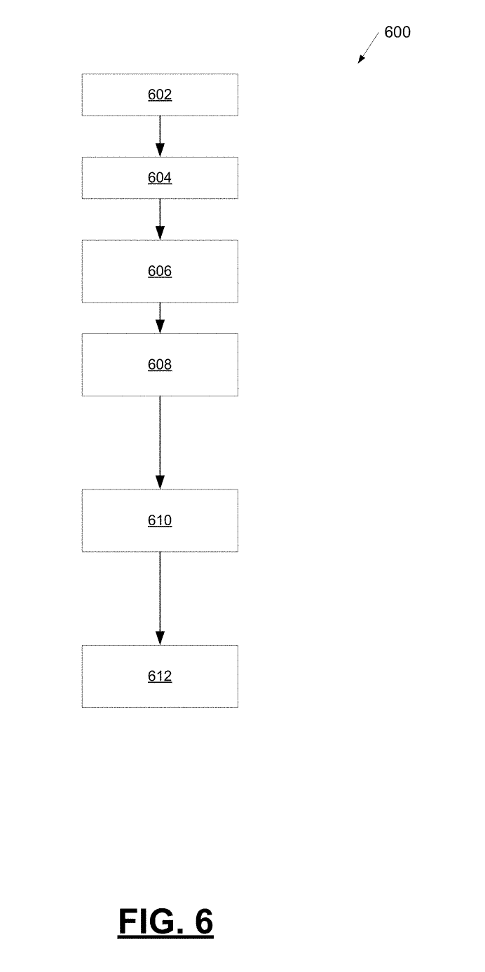

FIG. 6 is a process flow chart depicting an example process 600 that can be performed by an example lane change speed management system 100. The order of operation within the method is not limited to the sequential execution as illustrated in the figure, but may be performed in one or more varying orders as applicable and in accordance with the present disclosure. In various embodiments, the method can be scheduled to run based on one or more predetermined events, and/or can run continuously during operation of autonomous vehicle 10.

The example process 600 includes identifying a future lane change (operation 602). This may involve identifying a future lane change from road segments provided by a routing or mapping module.

The example process 600 includes identifying the starting point of a planned lane change (operation 604). This may also involve identifying the starting point of a lane change from road segments provided by the routing or mapping module.

The example process 600 includes measuring the travel distance available to complete the lane change (operation 606). This may also involve measuring the travel distance available to complete the lane change from road segments provided by the routing or mapping module.

The example process 600 includes determining a maximum speed for the vehicle at the lane change starting position (operation 608). This may involve determining the maximum speed based on a maximum lateral acceleration for the lane change for safety and/or for passenger comfort. The maximum speed (v_max) for the autonomous vehicle at the lane change starting position may be determined by v_max=(length_of_lane_change)*sqrt((a_lat)/(2*lane_sep)), wherein a_lat=lateral acceleration and lane_sep=estimated width of the lane. In this example, a_lat=0.3 m/s² and lane_sep=3.6 m.

The example process 600 includes setting a target speed limit at a plurality of intermediate points (operation 610). This may involve setting an interpolated speed limit at a plurality of intermediate points between the current position and the lane change starting position and setting the target speed limit at each of the intermediate points by choosing for each intermediate point the minimum of the interpolated speed limit at the intermediate point and any additional speed limit imposed at the intermediate point. For instance, if there are four equal-distance intermediate points between the current position of the autonomous vehicle and the lane change starting position, then at each intermediate point the speed limit should be reduced by at least 20% of the overall required speed reduction (e.g., if current speed is 50 mph and max speed at the lane change starting position is 40 mph, then the max speed limit at intermediate point one could be 48 mph, the max speed limit at intermediate point two could be 46 mph, the max speed limit at intermediate point three could be 44 mph, the max speed limit at intermediate point four could be 42 mph, and the max speed limit at the lane change starting position could be 40 mph.) The maximum speed limit at an intermediate point could be lower if some additional speed limit is imposed at the intermediate point, such as a speed bump in the road requiring the vehicle to reduce its speed further.

In the example process 600, the target speed limits are communicated as speed constraints to vehicle controls (operation 612). Responsive to the speed constraints, the vehicle controls may operate the vehicle to not exceed the speed limits specified by the speed constraints.

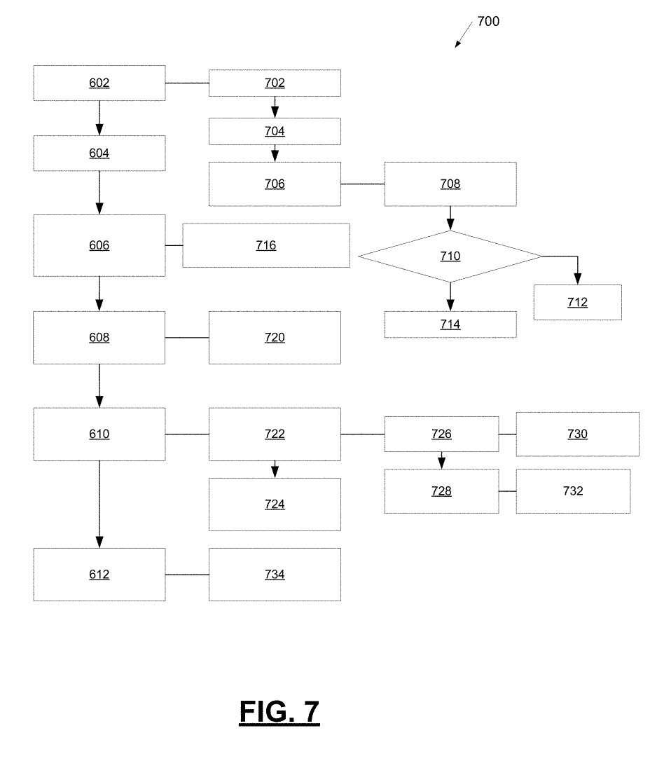

FIG. 7 is a process flow chart depicting another example process 700 that can be performed by an example lane change speed management system 100. The order of operation within the method is not limited to the sequential execution as illustrated in the figure, but may be performed in one or more varying orders as applicable and in accordance with the present disclosure. In various embodiments, the method can be scheduled to run based on one or more predetermined events, and/or can run continuously during operation of autonomous vehicle 10.

The example process 700 includes operations similar to operations in example process 600. The example process 700 includes identifying a future lane change (operation 602), identifying the starting point of a planned lane change (operation 604), measuring the travel distance available to complete the lane change (operation 606), determining a maximum speed at the lane change starting position (operation 608), setting a target speed limit at a plurality of intermediate points (operation 610), and communicating the target speed limits as speed constraints to vehicle controls (operation 612).

In the example process 700, identifying a future lane change (operation 602) includes receiving road segments (operation 702), identifying a potential lane change from the road segments (operation 704), and determining if a potential lane change is a future lane change (operation 706). Determining if a potential lane change is a future lane change (operation 706) includes determining the travel distance available to complete the lane change (e.g., travel distance 410) (operation 708) and determining if the travel distance available to complete the lane change is short (e.g., not greater than 2 times the vehicle length), i.e., a short lane change (decision 710). If the potential lane is a short lane change (yes at decision 710), the potential lane change is disregarded (operation 712). If the potential lane is not a short lane change (no at decision 710), the potential lane change is identified as a future lane change (operation 714). This decision process acts as a high pass filter to filter out lateral changes (e.g., short lane changes) that may not be true lane changes.

In the example process 700, measuring the travel distance available to complete the lane change (operation 606) includes measuring the distance available for the lane change as allowed by road markings (e.g., road signs, speed bump, etc.) (operation 716). In other examples, measuring the travel distance may include measuring the diagonal travel distance (e.g., the diagonal distance from point 408 to point 412) instead of measuring the forward travel distance.

In the example process 700, determining a maximum speed at the lane change starting position (operation 608) includes determining the maximum speed based on not exceeding the maximum lateral acceleration that ensures an acceptable level of passenger comfort (operation 720).

In the example process 700, setting a target speed limit at a plurality of intermediate points (operation 610) includes setting an interpolated speed limit at a plurality of intermediate points (operation 722) and setting a target speed limit by choosing between the minimum of the interpolated speed limit and some other applicable speed limit (operation 724). Setting an interpolated speed limit at a plurality of intermediate points (operation 722) includes identifying a plurality of intermediate points (operation 726) and identifying an interpolated speed limit at each of the intermediate points (operation 728). Identifying a plurality of intermediate points (operation 726) includes identifying a plurality of points spaced the same distance apart (operation 730). As an example, the distance may be 0.5 meters. Identifying an interpolated speed limit at each intermediate point (operation 728) may include identifying a linearly interpolated speed limit at each intermediate point (operation 732).

Finally, in the example process 700, communicating the target speed limits as speed constraints to vehicle controls (operation 612) results in the vehicle being controlled in accordance with the target speed limits (operation 734).

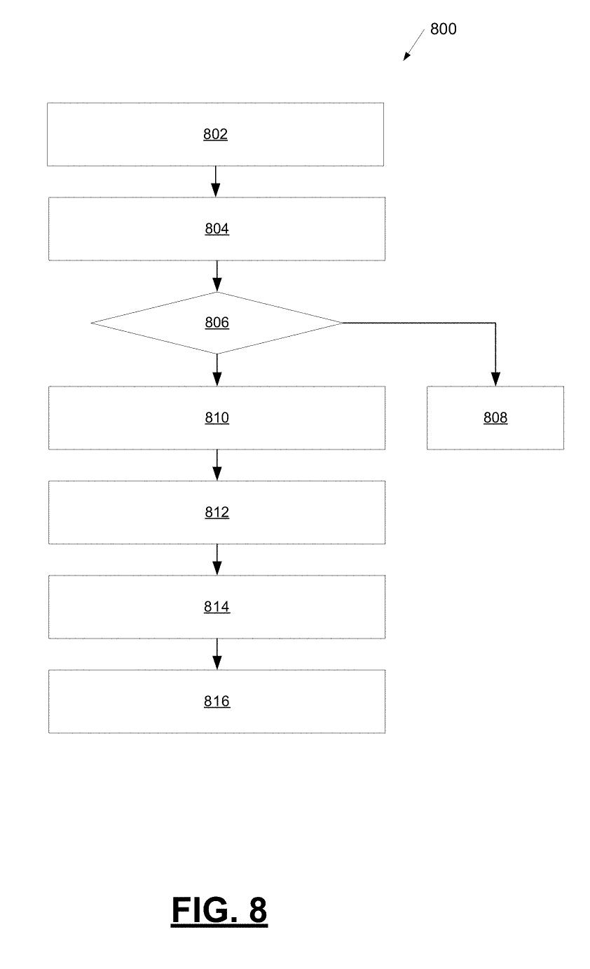

FIG. 8 is a process flow chart depicting another example process 800 that can be performed by an example lane change speed management system 100. The order of operation within the method is not limited to the sequential execution as illustrated in the figure, but may be performed in one or more varying orders as applicable and in accordance with the present disclosure. In various embodiments, the method can be scheduled to run based on one or more predetermined events, and/or can run continuously during operation of autonomous vehicle 10.

The example process 800 includes identifying a potential lane change (operation 802). After the potential lane change is identified, the travel distance available to complete the lane change is determined (operation 804). If the travel distance available to complete the lane change is short (e.g., not greater than 2 times the vehicle length), i.e., a short lane change (yes at decision 806), the lane change is disregarded (operation 808). If the travel distance available to complete the lane change is not short (no at decision 806), the travel distance available for the autonomous vehicle to complete the lane change is measured (operation 810). The travel distance is applied as an input to a function that outputs the maximum speed allowed for the autonomous vehicle upon starting the lane change (operation 812). A linear interpolation between the speed limit at the current location and the speed limit at the start of the lane change is performed for a number of intermediate points between the current location and the starting point (operation 814). At each intermediate point, the minimum of the interpolated speed limit and any pre-existing speed limit is selected for the intermediate point (operation 816).

In one embodiment, provided is a processor-implemented method in an autonomous vehicle for speed management during a lane change. The method comprises identifying, by a processor, a planned future lane change, identifying, by the processor, the starting position of the future lane change, measuring, by the processor, the travel distance available to complete the lane change, determining, by the processor, the maximum speed for the autonomous vehicle at the lane change starting position based on the travel distance, setting, by the processor, an interpolated speed limit at a plurality of intermediate points between the current position and the lane change starting position, setting, by the processor, a target speed limit at each of the intermediate points by choosing for each intermediate point the minimum of the interpolated speed limit at the intermediate point and any additional speed limit at the intermediate point, and communicating, by the processor, the target speed limit at the intermediate points as speed constraints to a vehicle control module.

These aspects and other embodiments may include one or more of the following features. Identifying a planned future lane change may comprise receiving a plurality of road segments from a router module, parsing the road segments to identify a potential lane change, and determining that the potential lane change is a future lane change. Determining that the potential lane change is a future lane change may comprise determining if the travel distance available to complete the lane change is short, determining that the potential lane change is not a future lane change when the travel distance available to complete the lane change is below a threshold level, and determining that the potential lane change is a future lane change when the travel distance available to complete the lane change is greater than or equal to a threshold level. Measuring the travel distance available to complete the lane change may comprise measuring the distance available for the lane change as allowed by road markings. Determining the maximum speed for the autonomous vehicle at the lane change starting position may comprise one or more of determining the maximum speed based on a maximum lateral acceleration for a safe lane change and determining the maximum speed based on a maximum lateral acceleration for passenger comfort during the lane change. The maximum speed (v_max) for the autonomous vehicle at the lane change starting position may be determined by v_max=(length_of_lane_change)*sqrt((a_lat)/(2*lane_sep)), wherein a_lat=lateral acceleration and lane_sep=estimated width of the lane.

Setting an interpolated speed limit at a plurality of intermediate points between the current position and the lane change starting position may comprise identifying a plurality of intermediate points between the current position and the lane change starting position and identifying an interpolated speed limit at each of the intermediate points between the current position and the lane change starting position. Identifying a plurality of intermediate points may comprise identifying a plurality of intermediate points between the current position and the lane change starting position with a constant, fixed distance between each intermediate point. The fixed distance may be 0.5 meters between each intermediate point. Identifying an interpolated speed limit may comprise linearly interpolating between the speed limit at the current position and the speed limit at the lane change starting position to identify an interpolated speed limit at each of the intermediate points. An additional speed limit may comprise a speed limit determined based on some other path travel condition such as a speed bump, legal speed limit, or obstacle in travel path. The vehicle control module may control the vehicle to not exceed the target speed limits at the lane change starting position and the intermediate points.

In another embodiment, a system is provided for controlling an autonomous vehicle. The autonomous vehicle comprises a speed management module comprising one or more processors configured by programming instructions encoded in non-transient computer readable media. The speed management module is configured to identify a planned future lane change, identify the starting position of the future lane change, measure the travel distance available to complete the lane change, determine a maximum speed for the autonomous vehicle at the lane change starting position based on the travel distance, set an interpolated speed limit at a plurality of intermediate points between the current position and the lane change starting position, set a target speed limit at each of the intermediate points by choosing for each intermediate point the minimum of the interpolated speed limit at the intermediate point and any additional speed limit at the intermediate point, and communicate the target speed limit at the intermediate points as speed constraints to a control module.

These aspects and other embodiments may include one or more of the following features. The speed management module may be further configured to receive a plurality of road segments from a router module that comprises one or more processors configured by programming instructions encoded in non-transient computer readable media wherein the router module is configured to plan the route of an autonomous vehicle, provide future path segments of the route, and identify a lane change in the future path segments. The speed management module may be further configured to parse the road segments to identify a potential lane change and determine that the potential lane change is a future lane change. The speed management module may be further configured to measure the travel distance available to complete the lane change, determine that the potential lane change is not a future lane change when the travel distance available to complete the lane change is below a threshold level, and determine that the potential lane change is a future lane change when the travel distance available to complete the lane change is greater than or equal to a threshold level. The speed management module may be further configured to set an interpolated speed limit at the plurality of intermediate points between the current position and the lane change starting position by linearly interpolating between the speed limit at the current position and the speed limit at the lane change starting position to identify an interpolated speed limit at each of the intermediate points. The system may further comprise a control module comprising one or more processors configured by programming instructions encoded in non-transient computer readable media wherein the control module is configured to receive the speed constraints and control the vehicle to not exceed the target speed limits set in the speed constraints.

In another embodiment, an autonomous vehicle is provided. The autonomous vehicle comprises a sensing device, a router module, a speed management module, and a control module. The sensing device is configured to determine the location of the vehicle along a route. The router module comprises one or more processors configured by programming instructions encoded in non-transient computer readable media and is configured to provide road segments for the route based on the current location of the vehicle and designate a planned future lane change in the road segments. The speed management module comprises one or more processors configured by programming instructions encoded in non-transient computer readable media and is configured to identify the planned future lane change, identifying the starting position of the future lane change, measure the travel distance available to complete the lane change, determine a maximum speed for the autonomous vehicle at the lane change starting position based on the travel distance, set an interpolated speed limit at a plurality of intermediate points between the current position and the lane change starting position, set a target speed limit at each of the intermediate points by choosing for each intermediate point the minimum of the interpolated speed limit at the intermediate point and any additional speed limit at the intermediate point, and communicate the target speed limit at the intermediate points as speed constraints to a control module. The control module comprises one or more processors configured by programming instructions encoded in non-transient computer readable media and is configured to receive the speed constraints and control the vehicle to not exceed the target speed limits set in the speed constraints.

These aspects and other embodiments may include one or more of the following features. The speed management module may be further configured to receive the plurality of road segments from the router module, parse the road segments to identify a potential lane change, and determine that the potential lane change is a future lane change. The speed management module may be further configured to measure the travel distance available to complete the lane change, determine that the potential lane change is not a future lane change when the travel distance available to complete the lane change is below a threshold level, and determine that the potential lane change is a future lane change when the travel distance available to complete the lane change is greater than or equal to a threshold level.

While at least one exemplary embodiment has been presented in the foregoing detailed description, it should be appreciated that a vast number of variations exist. It should also be appreciated that the exemplary embodiment or exemplary embodiments are only examples, and are not intended to limit the scope, applicability, or configuration of the disclosure in any way. Rather, the foregoing detailed description will provide those skilled in the art with a convenient road map for implementing the exemplary embodiment or exemplary embodiments. It should be understood that various changes can be made in the function and arrangement of elements without departing from the scope of the disclosure as set forth in the appended claims and the legal equivalents thereof.

What is claimed is:

1. A processor-implemented method in an autonomous vehicle for speed management during a lane change, the method comprising:
identifying, by a processor, a planned future lane change;
identifying, by the processor, the starting position of the future lane change;
measuring, by the processor, the travel distance available to complete the lane change;
determining, by the processor, the maximum speed for the autonomous vehicle at the lane change starting position based on the travel distance;
setting, by the processor, an interpolated speed limit at a plurality of intermediate points between the current position and the lane change starting position;
setting, by the processor, a target speed limit at each of the intermediate points by choosing for each intermediate point the minimum of the interpolated speed limit at the intermediate point and any additional speed limit at the intermediate point; and
communicating, by the processor, the target speed limit at the intermediate points as speed constraints to a vehicle control module.

2. The method of claim 1 wherein identifying a planned future lane change comprises:
receiving a plurality of road segments from a router module;
parsing the road segments to identify a potential lane change; and
determining that the potential lane change is the planned future lane change.

3. The method of claim 2 wherein determining that the potential lane change is the planned future lane change comprises:
determining the travel distance available to complete the lane change;
determining that the potential lane change is not the planned future lane change when the travel distance available to complete the lane change is below a threshold level; and
determining that the potential lane change is the planned future lane change when the travel distance available to complete the lane change is greater than or equal to a threshold level.

4. The method of claim 1 wherein measuring the travel distance available to complete the lane change comprises measuring the distance available for the lane change as allowed by road markings.

5. The method of claim 1 wherein determining the maximum speed for the autonomous vehicle at the lane change starting position comprises one or more of:
determining the maximum speed based on a maximum lateral acceleration for a safe lane change; and
determining the maximum speed based on a maximum lateral acceleration for passenger comfort during the lane change.

6. The method of claim 1 wherein the maximum speed (v_max) for the autonomous vehicle at the lane change starting position is determined by v_max=(length_of_lane_change)*sqrt((a_lat)/(2*lane_sep)), wherein a_lat=lateral acceleration and lane_sep=estimated width of the lane.

7. The method of claim 1 wherein setting an interpolated speed limit at a plurality of intermediate points between the current position and the lane change starting position comprises:
identifying a plurality of intermediate points between the current position and the lane change starting position; and
identifying an interpolated speed limit at each of the intermediate points between the current position and the lane change starting position.

8. The method of claim 7 wherein identifying a plurality of intermediate points comprises identifying a plurality of intermediate points between the current position and the lane change starting position with a constant, fixed distance between each intermediate point.

9. The method of claim 8 wherein the fixed distance is 0.5 meters between each intermediate point.

10. The method of claim 8 wherein identifying an interpolated speed limit comprises linearly interpolating between the speed limit at the current position and the speed limit at the lane change starting position to identify an interpolated speed limit at each of the intermediate points.

11. The method of claim 1 wherein an additional speed limit comprises a speed limit determined based on some other path travel condition such as a speed bump, legal speed limit, or obstacle in travel path.

12. The method of claim 1 wherein the vehicle control module controls the vehicle to not exceed the target speed limits at the lane change starting position and the intermediate points.

13. A system for controlling an autonomous vehicle comprising a speed management module comprising one or more processors configured by programming instructions encoded in non-transient computer readable media, the speed management module configured to:
identify a planned future lane change;
identify the starting position of the future lane change;
measure the travel distance available to complete the lane change;
determine a maximum speed for the autonomous vehicle at the lane change starting position based on the travel distance;
set an interpolated speed limit at a plurality of intermediate points between the current position and the lane change starting position;
set a target speed limit at each of the intermediate points by choosing for each intermediate point the minimum of the interpolated speed limit at the intermediate point and any additional speed limit at the intermediate point; and
communicate the target speed limit at the intermediate points as speed constraints to a control module.

14. The system of claim 13, wherein the speed management module is further configured to:
receive a plurality of road segments from a router module comprising one or more processors configured by programming instructions encoded in non-transient computer readable media, the router module configured to plan the route of an autonomous vehicle, provide future path segments of the route, and identify a lane change in the future path segments;
parse the road segments to identify a potential lane change; and
determine that the potential lane change is a future lane change.

15. The system of claim 14, wherein the speed management module is further configured to:
measure the travel distance available to complete the lane change;
determine that the potential lane change is not a future lane change when the travel distance available to complete the lane change is below a threshold level; and
determine that the potential lane change is a future lane change when the travel distance available to complete the lane change is greater than or equal to a threshold level.

16. The system of claim 13, wherein the speed management module is further configured to set an interpolated speed limit at the plurality of intermediate points between the current position and the lane change starting position by linearly interpolating between the speed limit at the current position and the speed limit at the lane change starting position to identify an interpolated speed limit at each of the intermediate points.

17. The system of claim 13, further comprising a control module comprising one or more processors configured by programming instructions encoded in non-transient computer readable media, the control module configured to receive the speed constraints and control the vehicle to not exceed the target speed limits set in the speed constraints.

18. An autonomous vehicle, comprising:
a sensing device configured to determine the location of the vehicle along a route;
a router module comprising one or more processors configured by programming instructions encoded in non-transient computer readable media, the router module configured to provide road segments for the route based on the current location of the vehicle and designate a planned future lane change in the road segments;
a speed management module comprising one or more processors configured by programming instructions encoded in non-transient computer readable media, the speed management module configured to:
identify the planned future lane change;
identifying the starting position of the future lane change;
measure the travel distance available to complete the lane change;
determine a maximum speed for the autonomous vehicle at the lane change starting position based on the travel distance;
set an interpolated speed limit at a plurality of intermediate points between the current position and the lane change starting position;
set a target speed limit at each of the intermediate points by choosing for each intermediate point the minimum of the interpolated speed limit at the intermediate point and any additional speed limit at the intermediate point; and
communicate the target speed limit at the intermediate points as speed constraints to a control module; and
a control module comprising one or more processors configured by programming instructions encoded in non-transient computer readable media, the control module configured to receive the speed constraints and control the vehicle to not exceed the target speed limits set in the speed constraints.

19. The autonomous vehicle of claim 18, wherein the speed management module is further configured to:
receive the plurality of road segments from the router module;
parse the road segments to identify a potential lane change; and
determine that the potential lane change is a future lane change.

20. The autonomous vehicle of claim 19, wherein the speed management module is further configured to:
measure the travel distance available to complete the lane change;
determine that the potential lane change is not a future lane change when the travel distance available to complete the lane change is below a threshold level; and
determine that the potential lane change is a future lane change when the travel distance available to complete the lane change is greater than or equal to a threshold level.
